(19) United States
(12) Patent Application Publication
(10) Pub. No.: US 2026/0317130 A1
(43) Pub. Date: Oct. 15, 2026

(54) INLINE RAIL CARRIER

(71) Applicant: Garlock Safety Systems, Inc., PLYMOUTH, MN (US)

(72) Inventors: Michael Stuart Halvorson, Maple Grove, MN (US); Jacob Ronald Thieschafer, Coon Rapids, MN (US)

(21) Appl. No.: 19/547,013

(22) Filed: Feb. 23, 2026

Related U.S. Application Data
(60) Provisional application No. 63/788,349, filed on Apr. 14, 2025.

(51) Int. Cl. B66C 1/62; E04F 11/18

(52) U.S. Cl. CPC B66C 1/62; E04F 11/1865

(57) ABSTRACT

A rail carrier includes at least one base positioned on the bottom end, the base comprising a plurality of rail receiving holes and the rail receiving holes configured to receive one or more additional rails. The rail carrier further includes a rail body, the rail body comprising at least one vertical portion fixedly attached to the base, at least one horizontal portion fixedly attached to the vertical portion, and at least one hoisting member configured to receive a hoisting mechanism. The vertical portion of the rail body extends through at least a portion of the plurality of rail receiving holes. The rail carrier can thus be hoisted to a desired location via the hoisting mechanism, and the additional rails can thereafter be unloaded and installed as desired. The rail carrier can be installed in addition to the additional rails.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Railings for roofing applications are often installed to help prevent and protect against falls. Installation of these railings requires hoisting individual rails up to a roof and individually installing the rails on the roof. Often, hoisting railing upon a roof can require many iterations of using a crane, other lifting machines, or manual hauling, to hoist individual sections of railing up to the roof. This can be time consuming and repetitive. Therefore, an application in which roofing can be transported in bulk, without the need for repetitive hoisting is desirable.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In at least one embodiment, a rail carrier for moving one or more guard rails from one location to another location comprises at least one base and a rail body. The at least one base comprises a plurality of rail receiving holes, the rail receiving holes configured to receive one or more guard rails. The rail body comprises at least one vertical portion fixedly attached to the base, at least one horizontal portion fixedly attached to the vertical portion, and at least one transport handle , wherein the vertical portion of the rail body extends through at least a portion of the plurality of rail receiving holes.

In some embodiments, a system for moving one or more guard rails from one location to another location, the system comprises at least one rail carrier comprising: at least one base comprising a plurality of rail receiving holes, the rail receiving holes configured to receive one or more guard rails; and a rail body, the rail body comprising at least one vertical portion fixedly attached to the base, at least one horizontal portion fixedly attached to the vertical portion, and at least one transport handle , wherein the vertical portion of the rail body extends through at least a portion of the plurality of rail receiving holes. At least one guard rail has a stored position within the rail carrier and an installed position. The at least one guard rail has at least one vertical portion, and, in the stored position, the at least one vertical portion is received in at least one of the rail receiving holes of the base. A locking mechanism engages the at least one guard rail with the rail carrier in at least the stored position. In at least one embodiment, the locking mechanism comprises a pin that extends through a first end of the base, the at least one guard rail, the rail body, and a second end of the base. In some embodiments, multiple rail carriers can be vertically stacked. For example, in one embodiment of the system, an upper rail carrier is stacked upon a lower rail carrier, and the at least one transport handle of the lower carrier is engaged with a receiving cavity of the upper rail carrier. In some embodiments, a stacking pin extends through the base of the upper rail carrier and the transport handle of the lower rail carrier to secure the carriers in this vertically stacked assembly.

In further embodiments, a method for transporting a plurality of guard rails from a first location to a second location comprises inserting at least one guard rail into one of a plurality of rail receiving holes in a base of a rail carrier in the first position, the rail carrier further comprising a rail body having at least one vertical portion, at least one horizontal portion connected to the vertical portion, and a transport handle; locking the at least one guard rail into a stored position within the rail carrier by engaging a locking mechanism with the at least one guard rail, the base of the rail carrier, and the rail body; and maneuvering the rail carrier from the first position to the second position by engaging a lifting mechanism with the transport handle. The lifting mechanism may be a hoisting mechanism, a forklift, or similar equipment that can move and lift the carrier assembly.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a perspective view of one embodiment of a rail carrier, according to one or more embodiments of the present disclosure.

FIG. 2 is an exploded view of the rail carrier of FIG. 1.

FIG. 3A is a perspective view of a base of the rail carrier of FIGS. 1-2.

FIG. 3B is an additional perspective view of the base of the rail carrier of FIGS. 1-3A.

FIG. 4A is an exploded view of the rail carrier of FIGS. 1-3B with additional rails.

FIG. 4B is a perspective view of the rail carrier of FIGS. 1-4A with the additional rails.

FIG. 5 is a vertically stacked embodiment of multiple rail carriers, according to one or more embodiments of the present disclosure.

FIG. 6 is a perspective view of an embodiment of the rail carrier and additional rails as installed upon a roof, according to one or more embodiments of the present disclosure.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, and/or components have not been described in detail so as not to obscure the discussion.

The present disclosure describes a novel and advantageous rail carrier. The rail carrier, according to the techniques of this disclosure, allows for hoisting of a multitude of rails via a single rail carrier. The rail carrier comprises at least one base comprising a plurality of rail receiving holes. The rail receiving holes within the base are configured to receive additional rails. The rail carrier comprises a rail body having at least one vertical member and at least one horizontal member The rail carrier also comprises at least one hoisting member, which allows for a hoisting mechanism (e.g. a crane or other lifting machine) to lift the rail carrier, along with the additional rails positioned within the rail carrier, up to a roof for installation upon the roof. The rail body, in some embodiments, is fixedly connected to the base. The rail carrier can also include, in some embodiments, forklift receiving members which allow for the rail carrier to be transported, along with any additional rails positioned therein, when the rail carrier is on the ground. The rail carrier disclosed herein is advantageous due to its ability to allow for secure and bulk transportation of multiple rails, thereby increasing the efficiency of hauling rails to a roof. Furthermore, the rail carrier is advantageous as the rail carrier can remain up on the roof and engaged to one or more of the guard rails to form part of the roof railing.

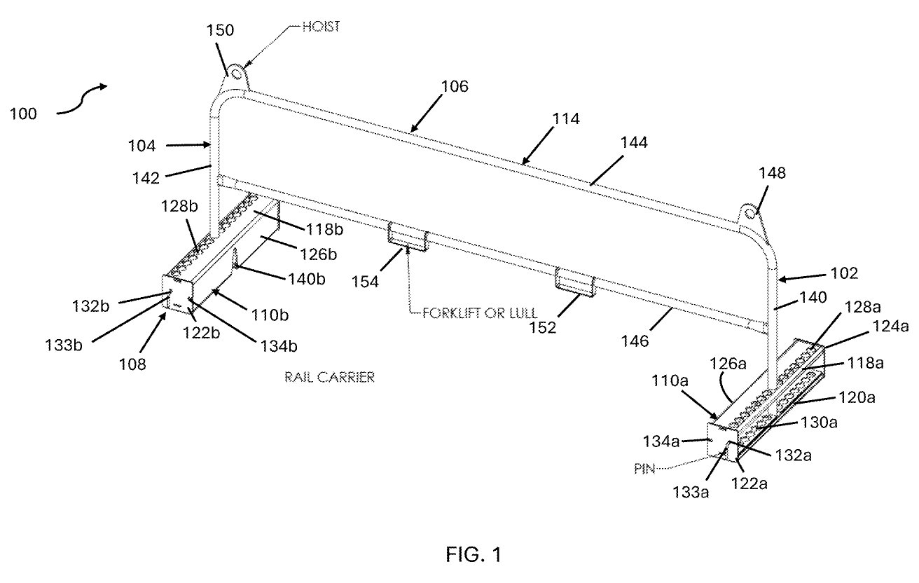

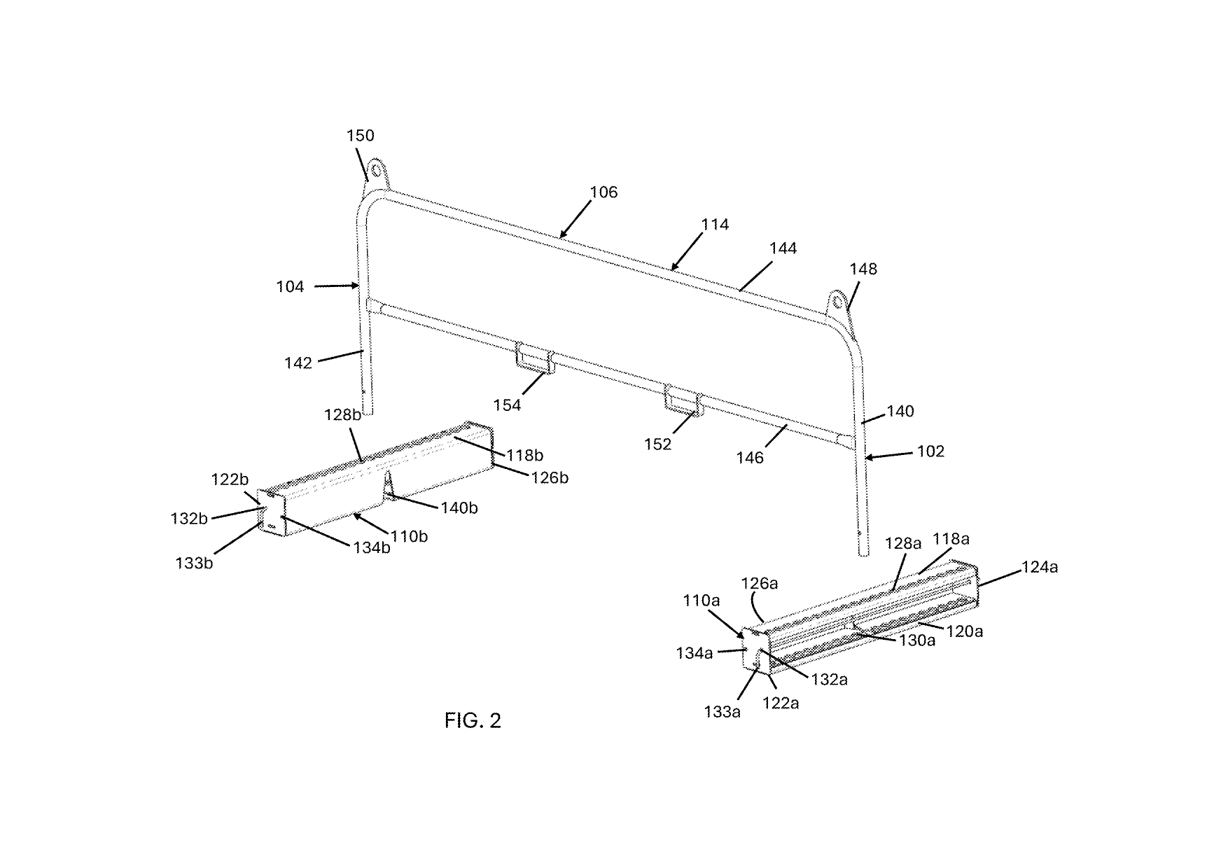

FIGS. 1 and 2 depict one embodiment of a rail carrier 100. Rail carrier 100 includes first side 102, second side 104, top end 106, and bottom end 108. Rail carrier 100 further includes at least one base 110 and rail body 114 spanning between first side 102 and second side 104. Although FIGS. 1-2 show the rail carrier 100 with two bases 110a and 110b, it is contemplated that a single base could be used or three or more bases could be used depending on the configuration of rail body 114 or the application for the guard rail.

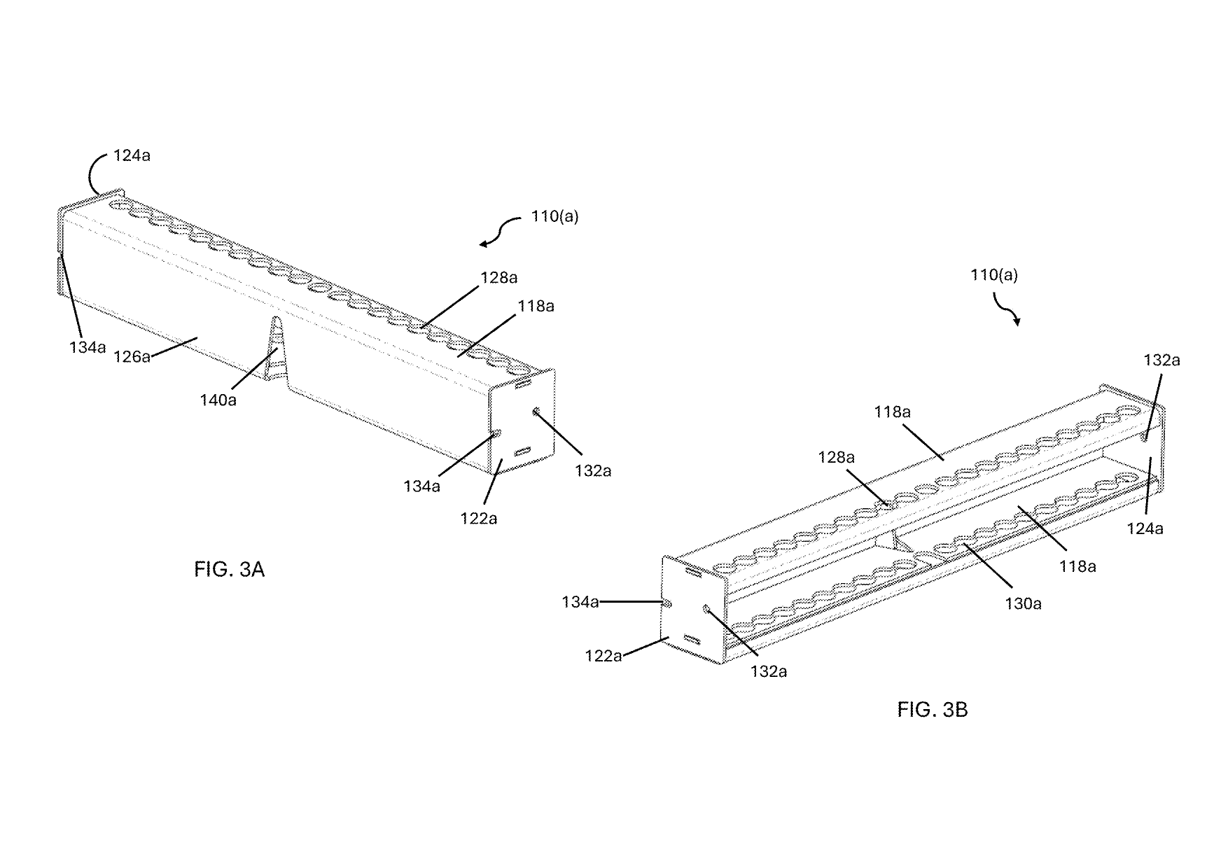

FIGS. 3A and 3B depict first base 110a. It is understood that, in some embodiments, the structures of first base 110a and second base 110b are analogous. Thus, the structure of first base 110a as depicted in FIGS. 3A-B is the same as that of second base 110b, according to one or more embodiments. Each of the bases 110, according to one or more embodiments of the inventions, include top rack plate 118, bottom rack plate 120, first end plate 122, second end plate 124, and side plate 126. Top rack plate 118 spans between first end plate 122 and second end plate 124 and includes rail receiving holes 128. Bottom rack plate 120 spans between first end plate 122 and second end plate 124 and includes rail receiving holes 130. In at least one embodiment, rail receiving holes 128 are vertically aligned with rail receiving holes 130. Each of the end plates 122, 124 include, in some embodiments, pin hole 132 and, in still further embodiments, support cavity 134. In some embodiments, each of bases 110 also include stacking cavity 140, which in the embodiment shown in FIGS. 1-3B is a notch in side plate 126. Pin hole 132 is configured to receive pin 133, which acts as a locking mechanism to lockably engage a guard rail to the carrier.

Rail body 114, in at least one embodiment, is similar in design to standard guard rails. Rail body 114 includes first vertical member 140 positioned on first side 102, second vertical member 142 positioned on second side 104, at least a first horizontal member 144 positioned at top end 106 and spanning between first vertical member 140 and second vertical member 142, and a second horizontal member 146 positioned between the first horizontal member 144 and bottom end 108 and spanning between first vertical member 140 and second vertical member 142. Each of vertical members 140, 142 includes rail body pin hole 156. Vertical member 142 includes rail body pinhole 158. First horizontal member 144, in at least one embodiment, includes at least one transport handle 147. As shown in this embodiment, the transport handle comprises first hoisting member 148 positioned adjacent to first side 102 and second hoisting member 150 positioned adjacent to second side 104. In some embodiments, second horizontal member 146 also includes at least one transport handle 147, which as shown in this embodiment is first forklift receiving member 152 and second forklift receiving member 154

In some embodiments, horizontal member 144 is integral with vertical members 140 and 142, and is therefore fixedly attached to vertical members 140 and 142. In other embodiments, horizontal member 144 is not integral with vertical members 140 and 142, but is fixedly attached thereto. In still other embodiments, horizontal member 144 is removably attached to vertical members 140 and 142. In some embodiments, horizontal member 146 is integral with vertical members 140 and 142, and is therefore fixedly attached to vertical members 140 and 142. In other embodiments, horizontal member 146 is not integral with vertical members 140 and 142, but is fixedly attached thereto. In still other embodiments, horizontal member 146 is removably attached to vertical members 140 and 142.

In some embodiments, first forklift receiving member 152 and second forklift receiving member 154 are fixedly attached to horizontal member 146. In some embodiments, first forklift receiving member 152 and second forklift receiving member 154 are removably attached to horizontal member 146. In some embodiments, first forklift receiving member 152 and second forklift receiving member 154 are moveable along horizontal member 146 to allow for varying widths between forklift tines.

Rail carrier 100 is formed by fixedly connecting rail body 114 to first base 110a and second base 110b. Rail body 114 extends between first base 110a and second base 110b, and hence spans between first side 102 and second side 104. Specifically, vertical member 140 is connected to first base 110a as vertical member 140 extends through rail receiving holes 128a and rail receiving holes 130a of rack plate 118a and rack plate 120a, respectively. In some embodiments, vertical member 140 is fixedly attached therein via welding. In other embodiments, vertical member 140 is detachable and removable from rail receiving holes 128a and 130a. Similarly, vertical member 142 is connected to second base 110b as vertical member 142 extends through rail receiving holes 128b and rail receiving holes 130b of rack plate 118b and rack plate 120b, respectively. In some embodiments, vertical member 142 is fixedly attached therein via welding. In other embodiments, vertical member 142 is detachable and removable form rail receiving holes 128b and 130b.

Vertical member 140 can be further secured to first base 110a via pin 133a. Pin 133a extends through pin hole 132a and through rail body pinhole 156 within vertical member 140. Pin 133a can be locked thereto by a suitable locking mechanism. Similarly, vertical member 142 can be further secured to second base 110b via pin 133b. Pin 133b extends through pin hole 132b and through rail body pinhole 158 within vertical member 142. Pin 133b can be locked thereto by a suitable locking mechanism. Though a pin is disclosed for securing rail body 114 to first base 110a and second base 110b, it is understood that any variety of suitable locking mechanisms can be used (e.g., bolts, latches, clasps, clips, magnets, etc.)

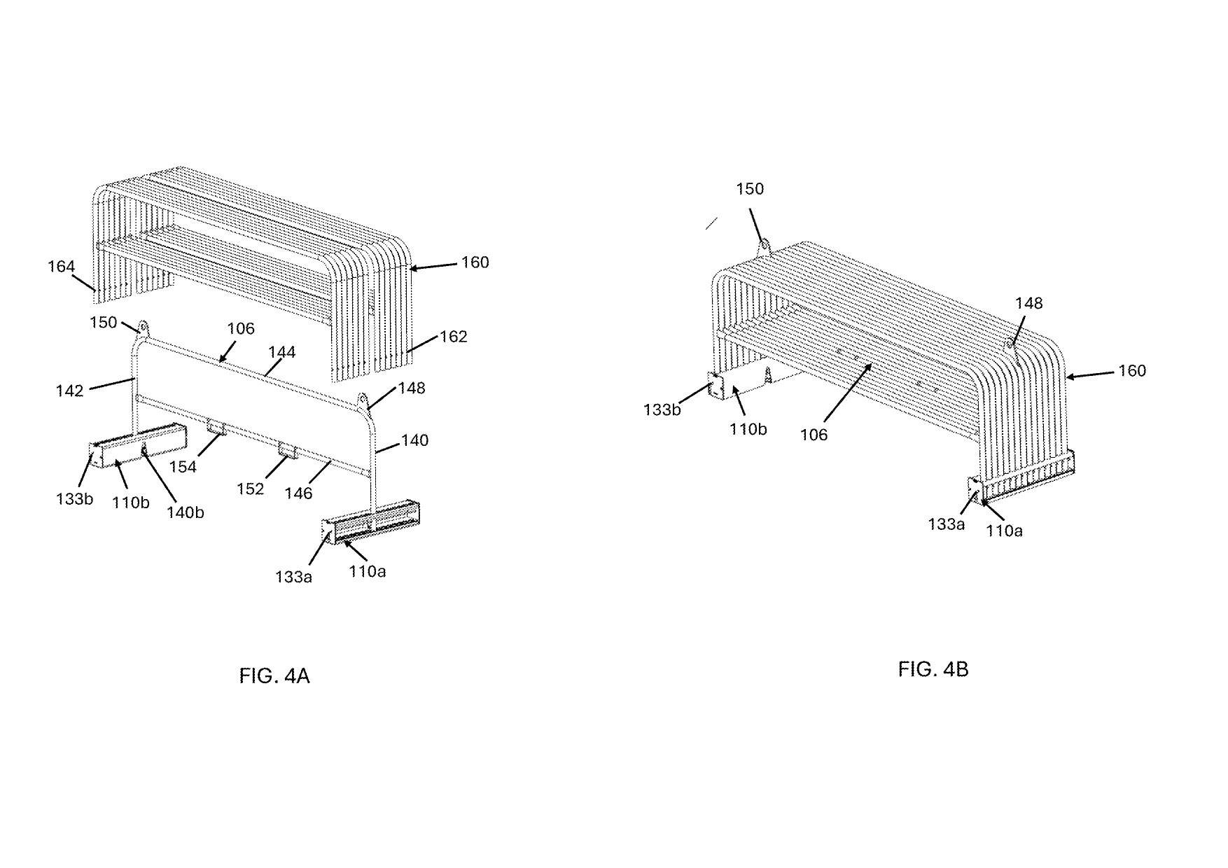

Rail carrier 100 can house additional rails 160. FIGS. 4A-4B depict rail carrier 100 with additional rails 160 housed within rail carrier 100. Additional rails 160 can fit within first base 110a and second base 110b. Specifically, additional rails 160 can be housed within rail receiving holes 128a and rail receiving holes 130a of first base 110a and within rail receiving holes 128b and rail receiving holes 130b of second base 110b.

Additional rails 160 can be secured to rail carrier 100 via pins 133a and 133b. As described, pins 133a and 133b can be used to provide additional security to rail body 114. Prior to inserting addition rails 160, pins 133a and 133b can be removed. After inserting additional rails 160 within rail receiving holes 128a and rail receiving holes 130a of first base 110a and within rail receiving holes 128b and rail receiving holes 130b of second base 110b, pins 133a and 133b can be reinserted. Specifically, pin 133a extends through pin hole 132a, through first additional rail pin holes 162, and through rail body pinhole 156 within vertical member 140. Similarly, pin 133b extends through pin hole 132b, through first additional rail pin holes 164, and through rail body pinhole 158 within vertical member 142. Though a pin is disclosed for securing additional rails 160 to first base 110a and second base 110b, it is understood that any variety of suitable locking mechanisms can be used (e.g., bolts, latches, clasps, clips, magnets, etc.)

In the depicted embodiment of FIGS. 4A-4B, fourteen additional rails 160 are housed within first base 110a and second base 110b. It is understood, however, that rail carrier 100 can be designed such that first base 110a and second base 110b can accommodate any number of additional rails 160. Further, the number of additional rails 160 can be less than the number of receiving holes contained within first base 110a and second base 110b.

In operation, rail carrier 100 can be used to haul and/or hoist additional rails 160. In one example, a forklift, or other suitable hauling mechanism, can transport rail carrier 100 and additional rails 160 via forklift tines being received within first forklift receiving member 152 and second forklift receiving member 154. In one example, rail carrier 100 and additional rails 160 can be hoisted by operation of a crane, or other suitable hoisting mechanism. In such an example, first hoisting member 148 and second hoisting member 150 can receive the hooks, or other connecting members, of the hoisting mechanism. Thereafter, the entirety of rail carrier 100 and additional rails 160 can be hoisted. As designed, rail carrier 100 can withstand at least 200 lbs. of force in any direction. Such a design allows for safe hoisting of rail carrier 100 along with to additional rails 160.

Rail carrier 100 of FIGS. 1-4B provides several advantages. Rail carrier 100 can house a plurality of additional rails, and therefore allows for such a plurality of additional rails to be moved, in bulk, via ground transportation (e.g., a forklift), or hoisted to an elevated area (e.g., via a crane). Rail carrier 100 allows for such transportation of additional rails while ensuring the additional rails are securely housed within rail carrier 100.

FIG. 4 depicts a vertically stacked embodiment of the rail carrier of FIGS. 1-3B according to one or more embodiments. FIG. 4 depicts stacked rail carrier assembly 400. Stacked rail carrier 400 includes upper rail carrier 402 and lower rail carrier 404. Upper rail carrier 402 includes first upper base 406a, second upper base 406b, and upper rail body 408. Lower rail carrier 404 includes first lower base 410a, second lower base 410b, and lower rail body 412.

First upper base 406a includes end plate 414a, end plate 416a, and side plate 418a. End plate 414a includes pin hole 420a and support cavity 422a. End plate 416a includes pin hole 426a and support cavity 428a. Pin 424a extends through pin holes 420a and 426a. Side plate 418a includes stacking cavity 432a. Second upper base 406b is structured akin to first upper base 406a.

First lower base 410a includes end plate 434a, end plate 436a, and side plate 438a. End plate 434a includes pin hole 440a and support cavity 442a. End plate 436a includes pin hole 446a and support cavity 448a. Pin 444a extends through pin holes 440a and 446a. Side plate 438a includes stacking cavity 452a. Second lower base 410b is structured akin to first lower base 410a.

Upper rail body 408 includes vertical member 454, vertical member 456, horizontal member 458, and horizontal member 460. Horizontal member 458 includes first hoisting member 462 and second hoisting member 464. Lower rail body 412 includes vertical member 466, vertical member 468, horizontal member 470, and horizontal member 472. Horizontal member 470 includes first hoisting member 474 and second hoisting member 476.

As depicted in FIG. 4, upper rail carrier 402 is stackable atop lower rail carrier 404. Specifically, upper rail carrier 402 is placed atop lower rail carrier 404 such that first hoisting member 474 of lower rail body 466 is received within stacking cavity 432a of first upper base 406a. Similarly, second hoisting member 476 of lower rail body 466 is received within a stacking cavity (not depicted) of second upper base 406b. Thus, first upper base 406a and second upper base 406b mate with lower rail body 412, thereby allowing for stacking of upper rail carrier 402 and lower rail carrier 404.

In some embodiments, an additional pin, or other locking mechanism, can be used to secure upper rail carrier 402 to lower rail carrier 404 after stacking. In one example, a pin can extend through support cavity 422a of first upper base 406a, through a cavity within first hoisting member 474 of lower rail body 412, and through support cavity 428a of first upper base 406a. Similarly, a pin can extend, on the opposite side, through support cavity 422b of second upper base 406b, through a cavity within second hoisting member 476 of lower rail body 412, and through support cavity 428b (not pictured) of second upper base 406b.

In some embodiments, such a locking mechanism can be used to support either upper rail carrier 402 or lower rail carrier 404 for the purpose of welding upper rail body 408 to first upper base 406a and second upper base 406b and/or welding lower rail body 412 to first lower base 410a and second lower base 410b. In some embodiments, the locking mechanism can be used to securely fasten the stacked rail carriers, to allow both rail carriers to be hoisted at the same time. It is understood that while two rail carriers are depicted as being stacked, any number of rail carriers can be stacked on top of one other via the same configuration described herein.

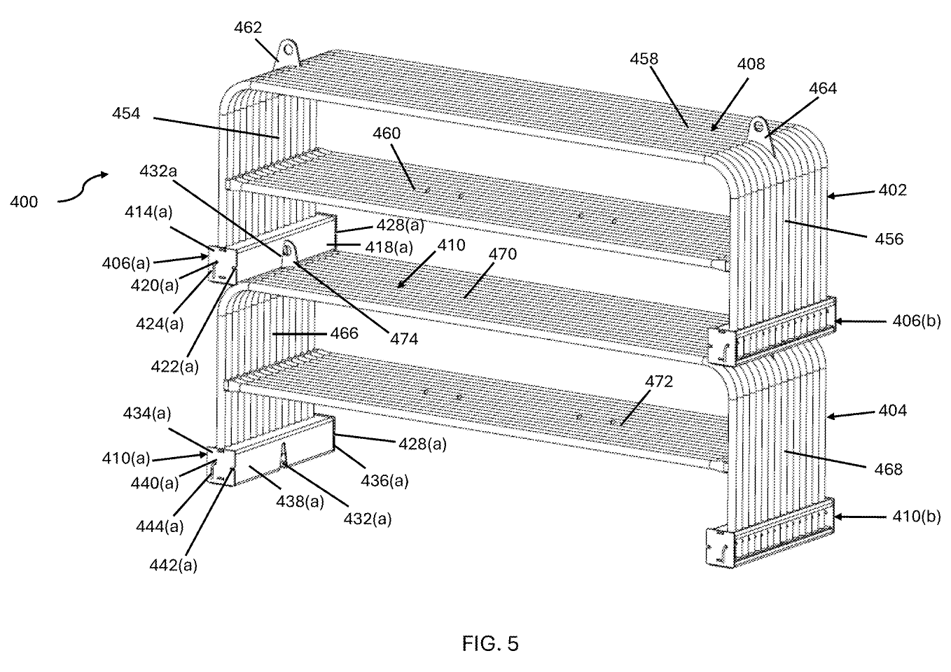

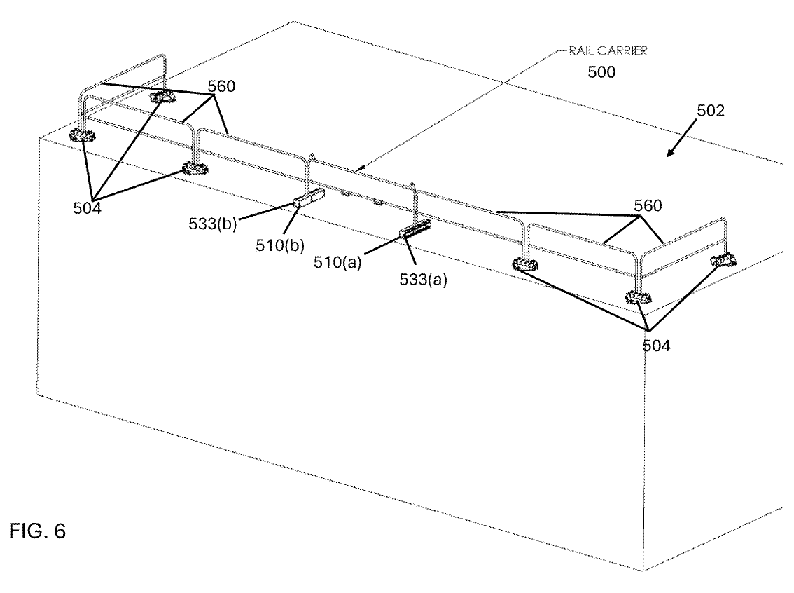

FIG. 5 depicts one embodiment of the rail carrier, according to one or more embodiments described herein, and the transported guard rails after installation on roof 502. FIG. 5 depicts rail carrier 500, comprising first base 510a, second base 510b, and rail body 514. First base 510a includes pin 533a and second base 510b includes pin 533b. FIG. 5 also depicts additional rails 560 and rail bases 504.

As depicted, after hoisting rail carrier 500 upon roof 502, rail carrier 500 can then be used as a part of the roof railing in addition to guard rails 560. First base 510a and second base 510b are configured to receive adjacent guard rails 560. In the installed position on the roof, pin 533a can be inserted within base 510a and a corresponding pin hole within the adjacent guard rail, and pin 533b can be inserted within base 510b and a corresponding pin hole within the adjacent guard rail. In at least one embodiment, the adjacent guard rails 560 that are engaged with the first base 510a and second base 510b abut rail body 514 in the installed position. The insertion of pins 533a and 533b can prevent rotation relative to rail carrier 500 and the additional adjacent rails of additional rails 560. The remainder of additional rails 560 are positioned in a desired configuration and held in place using rail bases 504. In some embodiments rail carrier 500 is configured to store the rail bases 504 for transport from a first location to the installation site such as the roof.

As depicted, rail carrier 500 is advantageous as it allows for hoisting each of guard rails 560. Further, after being used to hoist each of guard rails 560, rail carrier 500 can remain up on the roof and engaged to one or more of the guard rails 560 to form part of the roof railing. Thus, rail carrier 500 is functional even after being hauled to the destination where guard rails 560 are to be installed.

The techniques of this disclosure relate to a rail carrier which allows for the transportation and hoisting of additional rails in bulk, which is particularly suitable for roofing applications. As depicted through the figures and described throughout the specification, rails can be housed within a rail carrier, secured therein, hoisted to a desired location, and thereafter positioned as desired, with the rail carrier acting as a suitable rail.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the "a" or "an" are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

1. A rail carrier for moving one or more guard rails from one location to another location, the rail carrier comprising:
at least one base comprising a plurality of rail receiving holes, the rail receiving holes configured to receive one or more guard rails;
a rail body, the rail body comprising at least one vertical portion fixedly attached to the base, at least one horizontal portion fixedly attached to the vertical portion, and at least one transport handle, wherein the vertical portion of the rail body extends through at least a portion of the plurality of rail receiving holes.

2. The rail carrier of claim 1, wherein the at least one base comprises a first base positioned on the first side and a second base positioned on the second side.

3. The rail carrier of claim 2, wherein the at least one vertical portion of the rail body comprises a first vertical portion extending through at least a portion of the rail receiving holes and fixedly attached to the first base, and a second vertical portion extending through at least a portion of the rail receiving holes and fixedly attached to the second base.

4. The rail carrier of claim 1, wherein the at least one transport handle comprises a first hoisting member and a second hoisting member, the first hoisting member extending from the horizontal portion and being positioned on the first side, and the second hoisting member extending from the horizontal portion and being positioned on the second side.

5. The rail carrier of claim 4, wherein at least one of the first hoisting member and the second hoisting member comprises an elongated portion of material extending from the horizontal member and having at least one cavity for receiving the hoisting mechanism.

6. The rail carrier of claim 1, wherein the at least one vertical portion is integrally formed with the at least one horizontal portion.

7. The rail carrier of claim 1, wherein the at least one horizontal portion comprises a first horizontal portion and a second horizontal portion, the first horizontal portion being positioned at the top end, and the second horizontal portion being positioned between the first horizontal portion and the bottom end.

8. The rail carrier of claim 1, wherein the at least one transport handle comprises at least one forklift receiving mechanism extending from the at least one horizontal portion, the at least one forklift receiving mechanism configured to receive one or more tines of a forklift.

9. The rail carrier of claim 1, wherein the base comprises a first rack plate, a second rack plate, a first end plate, a second end plate, and a side plate, and wherein the plurality of rail receiving holes extend through the first rack plate and the second rack plate.

10. The rail carrier of claim 9, wherein the first end plate and the second end plate comprise at least one pin hole.

11. The rail carrier of claim 10, wherein the rail body further comprises at least one rail body pin hole extending through the rail body at a portion of the rail body housed within the base, the at least one rail body pin hole aligned with the at least one pin hole of the first end plate and the at least one pin hole of the second end plate.

12. The rail carrier of claim 11, further comprising a pin extending through the pin hole of the first end plate, the at least one rail body pin hole, and the pin hole of the second end plate of the base.

13. A system for moving one or more guard rails from one location to another location, the system comprising:
at least one rail carrier comprising:
at least one base comprising a plurality of rail receiving holes, the rail receiving holes configured to receive one or more guard rails; and
a rail body, the rail body comprising at least one vertical portion fixedly attached to the base, at least one horizontal portion fixedly attached to the vertical portion, and at least one transport handle , wherein the vertical portion of the rail body extends through at least a portion of the plurality of rail receiving holes;
at least one guard rail having a stored position and an installed position, the at least one guard rail having at least one vertical portion, wherein in the stored position, the at least one vertical portion is received in at least one of the rail receiving holes of the base; and
a locking mechanism engaging the at least one guard rail with the rail carrier.

14. The system of claim 13, wherein the at least one rail carrier comprises an upper rail carrier and a lower rail carrier, the upper rail carrier is stacked upon the lower rail carrier, and the at least one transport handle of the lower carrier is engaged with a receiving cavity of the upper rail carrier.

15. The system of claim 14, further comprising a stacking pin wherein the stacking pin extends through the base of the upper rail carrier and the transport handle of the lower rail carrier.

16. The system of claim 13, wherein the locking mechanism comprises a pin that extends through a first end of the base, the at least one guard rail, the rail body, and a second end of the base.

17. A method for transporting a plurality of guard rails from a first location to a second location and installing the plurality of guard rails, the method comprising:
inserting at least one guard rail into one of a plurality of rail receiving holes in a base of a rail carrier in the first position, the rail carrier further comprising a rail body having at least one vertical portion, at least one horizontal portion connected to the vertical portion, and a transport handle;
locking the at least one guard rail into a stored position within the rail carrier by engaging a locking mechanism with the at least one guard rail, the base of the rail carrier, and the rail body; and
maneuvering the rail carrier from the first position to the second position by engaging a lifting mechanism with the transport handle.

18. The method of claim 17, wherein the lifting mechanism is a hoisting mechanism or a forklift.

19. The method of claim 17, further comprising positioning one of the plurality of guard rails adjacent to the rail body and within one of the rail receiving holes of the base of the rail carrier in an installed position.

20. The method of claim 19, further comprising:
locking the at least one guard rail in the installed position by engaging the locking mechanism with the at least one guard rail, the base of the rail carrier and the rail body.
